(19) United States
(12) Patent Application Publication
(10) Pub. No.: US 2004/0205771 A1
(43) Pub. Date: Oct. 14, 2004

(54) System and method of generating and using proxy beans

(75) Inventors: Krishna Sudarshan, Cupertino, CA (US); Anurag Shekhar, Patna (IN); Moses Pachaipandian, Triplicane (IN)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Nextset Software Inc.

(21) Appl. No.: 10/833,758

(22) Filed: Apr. 27, 2004

Related U.S. Application Data
(63) Continuation of application No. 09/815,480, filed on Mar. 23, 2001.
(60) Provisional application No. 60/193,003, filed on Mar. 29, 2000.
(60) Provisional application No. 60/193,006, filed on Mar. 29, 2000.
(60) Provisional application No. 60/193,007, filed on Mar. 29, 2000.

(51) Int. Cl. G06F 9/00

(52) U.S. Cl. 719/316

(57) ABSTRACT

An enterprise JavaBeans architecture is provided which includes an application server having a container and a plurality of enterprise beans residing in the container, a remote server having a container and a plurality of proxy beans residing in the container and configured to communicate with the application server, and a plurality of client systems configured to communicate with the plurality of proxy beans of the remote server. The plurality of proxy beans are deployed on the remote server. A method of using proxy beans is provided which includes generating a plurality of proxy beans, deploying the plurality of proxy beans into the container of the remote server, and performing a method call on at least one of the plurality of proxy beans. The method also includes transmitting the method call to one of the plurality of enterprise beans located at the application server and accessing the enterprise bean having the method call.

### CROSS-REFERENCE TO RELATED APPLICATIONS

This application claims priority from U.S. provisional patent applications Serial Nos. 60/193,003, 60/193,006, and 60/193,007, all filed on Mar. 29, 2000, which are herein incorporated by reference for all purposes. The following applications, including this one, are being filed concurrently, and the disclosure of each of these applications is incorporated by reference into this application for all purposes: (1) U.S. patent application Ser. No. ______, entitled “System and Method of providing a Messaging Engine for an Enterprise JavaBeans-enabled Server to Achieve Container Managed Asynchronous Functionality”; and (2) U.S. patent application Ser. No. ______, entitled “System and Method of providing an Asynchronous Interface between a Client System and an Enterprise JavaBeans-enabled Server.”

### FIELD OF THE INVENTION

The present invention relates generally to systems and methods of developing objects for use with Enterprise JavaBeans (EJB) technology. Specifically, the present invention is directed to systems and methods of generating and using proxy beans, i.e., representations of actual EJBs deployed on remote servers.

### BACKGROUND OF THE INVENTION

The EJB architecture, developed by Sun Microsystems, Inc., is a standard component architecture for building distributed object-oriented applications in the Java programming language. A distributed object-oriented application is an application program in which parts of the application program are located in different physical locations. The EJB architecture allows application developers to build these distributed applications by combining components that are developed by using tools from multiple vendors. This architecture defines the contracts that enable these tools to develop and deploy components that can inter-operate at runtime.

The EJB architecture utilizes an EJB specification that defines the functions and operations of the components of the EJB architecture. Components are pre-developed modules of application code that run in an application server and that can be assembled into working application systems. The EJB specification provides a framework for the development and deployment of components. These components may be plugged into the EJB-enabled server to enhance the EJB-enabled server's functionality. For example, the components provided by one vendor can be easily integrated with the components provided by other vendors using the EJB specification.

FIG. 1 is a simplified block diagram of an EJB architecture 10 having a client system 12 and an EJB-enabled server 14 and configured to perform synchronous communication. The server has a number of components including a number of containers 16 and a number of enterprise beans 18. The server provides the system level services such as load balancing, scalability, and interaction with an application server (not shown). The server is an EJB-enabled server that is configured to host the containers.

Enterprise beans 18 are components of the EJB architecture that are developed once and then deployed on multiple EJB-enabled servers without recompilation or source code modification. Enterprise beans reside in the container 16, encapsulate application logic, and contain logic functions that operate on data stored in the EJB-enabled server 14 and a database 20.

The EJB architecture defines two types of enterprise beans 18, session beans and entity beans. A key difference between session and entity beans is the fact that an entity bean has a persistent state while a session bean models interactions but does not have a persistent state. Entity beans are associated with objects and persistent records in some sort of database (Resource Manager). In contrast, session beans do not represent database records but rather, represent extensions of the client application and are responsible for managing processes or tasks. The client system 12 accesses the session bean through the session bean's remote interface. Each session bean is an EJB instance associated with a single client system and is typically non-persistent. An entity bean represents information persistently stored in the database 20 and is associated with database transactions. The persistence of entity beans is handled by the entity beans themselves or by the container 16. The entity beans that represent a business object can be shared among multiple client systems 12.

To implement a bean, two interfaces need to be defined: a home interface and a remote interface. The home interface defines the bean's life cycle methods including methods for creating new beans, removing beans and finding beans. The enterprise bean's home interface defines the methods for the client system 12 to create, remove, and locate EJB objects of the same type (i.e., they are implemented by the same enterprise bean). The client system can locate the enterprise bean's home interface through the Java Naming and Directory Interface (JNDI) API. The remote interface defines the bean's business methods callable by the client system, i.e., the methods a bean presents to the outside world to do its work. Each EJB object is accessible via the enterprise bean's remote interface.

Containers 16 reside in the server 14 and are responsible for managing the interactions between a bean and its server. Each container is responsible for presenting a uniform interface between the bean and the server, creating new instances of the bean, and providing services such as concurrency, locking, persistence management, remote access, and security, to the enterprise beans 18. Multiple enterprise beans can be installed in and deployed from the same container. The container also creates a class that implements the home interface of an enterprise bean. The container is responsible for making the home interfaces of its deployed enterprise beans available to the client system 12 through JNDI.

In the EJB-enabled server 14, the enterprise beans 18 are deployed into the containers 16. The deployment process, illustrated in FIG. 2, begins when the container generates implementations of the home interface and the remote interface of the enterprise beans for use at runtime (step S-1). These implementations are then compiled to use remote method invocation (RMI) or any other such synchronous protocols as the protocol of communication with the EJB-enabled server (step S-2). RMI uses a synchronous mode of communication and altering the component contract would possibly result in unforeseen effects. The RMI protocol uses stubs and skeletons for communication between the client side and server side components. The skeletons 15 are generated classes that are located on the server side and stubs 13 are generated classes that are located on the client side (step S-3) (see also FIG. 3). Referring to FIG. 3, stubs 13 and skeletons 15 are responsible for making the method calls on the server 14 appear as if they were running locally on the client system 12. The stub 13 resides on the client system and is connected to the skeleton 15 via a network. The skeleton 15 is set up on a port at the EJB-enabled server side and listens for requests from the stub 13. When an object makes a method call on any home or remote interface of a bean, the control transfers from the calling object to the called object's stub. When the client system 12 invokes the method on the stub 13, the name of the method invoked and the values passed in as parameters are communicated to the skeleton 15. For example, in FIG. 3, the method invokes a create routine. The skeleton parses the incoming stream to properly invoke the method and the result is streamed back to the stub.

The EJB specification also defines the client-view contract (or client contract) and component contract. The client-view contract is the contract between the client and a container and provides a uniform development model for applications using enterprise beans as components. The client view contract of the enterprise bean includes home interface, remote interface, object identity, metadata interface, and handle. The component contract defines the contract between the enterprise bean and its container.

The EJB specification also defines various other aspects of the EJB architecture, e.g., the roles played by the various users and the runtime attributes of an enterprise bean called the Deployment Descriptor. In addition, the EJB specification supports various protocols including RMI and Internet Inter-Orb Protocol (IIOP). RMI is typically the default protocol that is supported by the EJB specification. RMI is the basis of distributed object systems and is responsible for making the distributed objects' location transparent, i.e., the object's location is unknown and unimportant to the client system. 12.

Using the RMI protocol, the EJB specification defines a synchronous mode of communication between the client system 12 and the server 14. Synchronous communication means that when a request is made from one object to another, the calling object will be blocked until it obtains a response from the called object. For example, when the client system makes a request, e.g., a method call, to the server, the client system making the call is blocked for the duration of the call and until a response is received (see FIG. 1). That is, the client system will be blocked until the request is communicated to the server, the request is processed by the server, and a result is returned to the client system or an exception occurs. One drawback of synchronous communication is that the client system is unable to process further requests from the user application until and unless the server has completed the previous request. This strictly sequential processing may not be necessary or appropriate for a number of applications. For instance if a client system is sending updates to a remote server and does not care about a reply from the server, and only expects the updates to reach the server reliably, a strictly synchronous behavior is not required and such applications are better served by an asynchronous model. In this case, the client system simply queues up updates and as long as is guaranteed reliable delivery to the server, is free to process other requests before even hearing back from the server.

As a result of the problems associated with synchronous communication and the need for asynchronous communication in a distributed environment, EJB-enabled servers 14 have been developed which provide asynchronous capabilities. Current EJB-enabled servers achieve asynchronous capability at the application level by implementing an EJB-Java Messaging Service (JMS) bridge 19 on the EJB-enabled server (see FIG. 4). One drawback of the EJB-JMS implementation is that the client system has to make JMS messaging calls that the EJB-enabled server understands and executes.

### SUMMARY OF THE INVENTION

The present invention is directed to systems and methods of creating and using proxy beans. A proxy bean is a representation of an actual enterprise bean that is deployed on a server local to a client system, i.e., a remote server. The proxy bean allows the client system to access the actual enterprise bean as if the actual enterprise bean were deployed locally on the remote server. When the client system performs a lookup operation, the client system accesses the proxy bean. The client system's method calls are made to the proxy bean and the remote server in which the proxy bean is located. The remote server forwards the method calls to the actual enterprise bean located in the application server. The proxy beans of the present invention are designed to maintain the client contract specified by the EJB specification, so that the client system is not able to differentiate between the actual bean and the proxy bean.

An enterprise JavaBeans architecture is provided which includes an application server having a container and a plurality of enterprise beans residing in the container, a remote server having a container and a plurality of proxy beans residing in the container and configured to communicate with the application server, and a plurality of client systems configured to communicate with the plurality of proxy beans of the remote server. The plurality of proxy beans are deployed on the remote server.

A method of using proxy beans is provided which includes generating a plurality of proxy beans, deploying the plurality of proxy beans into the container of the remote server, and performing a method call on at least one of the plurality of proxy beans. The method also includes transmitting the method call to one of the plurality of enterprise beans located at the application server and accessing the enterprise bean having the method call.

The present invention also allows for location transparency, in that a client system accessing a proxy bean does not need to know where the actual enterprise bean is located. The proxy beans are configured to know where the actual enterprise bean is located and is responsible for configuring the local server on which it is deployed to forward method invocations to and accept responses from the actual enterprise bean. The client system does not need to know where the actual enterprise bean is located or where it is executed.

One object of the present invention is application partitioning. The use of proxy beans in the present invention allows for simple maintenance of different applications in different locations.

Another object of the present-invention is firewall support. The use of proxy beans allows several client systems to make method calls on the proxy bean located at the remote server (as opposed to the actual EJB located at the application server). In this example, only the remote server makes calls to the actual EJB at the application server and therefore, only the remote server (as opposed to the numerous client systems that may be connected to the remote server) deals with any firewall between the clients/remote server and the application server with the actual EJB.

Yet another object of the present invention is better performance while operating in a secure environment with firewalls. When a client application accesses the bean using a protocol such as RMI, and a firewall exists between the client application and the bean, RMI tunnels over HTTP through port 80. This can have a performance impact on the client application. The present invention allows for the firewall to allow requests from the remote server to directly come over RMI instead of tunneling over HTTP.

It is a further object of the present invention that the proxy beans can be used in conjunction with asynchronous communication as described in the related co-pending patent applications, referred to above, to achieve increased system reliability and resource availability.

It is still a further object of the present invention to provide for scalability through use of remote servers, e.g., servers containing the proxy beans. The remote server may not be responsible for execution, that is, the application server is generally responsible for execution, and therefore, the remote server has ample resources to support additional client systems.

It is yet another object of the present invention to provide for data consistency. Since the proxy beans of the present invention do not directly access data but rather access data through actual enterprise beans, the data needs to be stored in one place and therefore, it is not necessary to maintain several databases which all need to be updated when data is changed.

### BRIEF DESCRIPTION OF THE DRAWINGS

FIG. 1 is a simplified block diagram of a prior art EJB architecture having a client system and a server and configured to communicate synchronously;

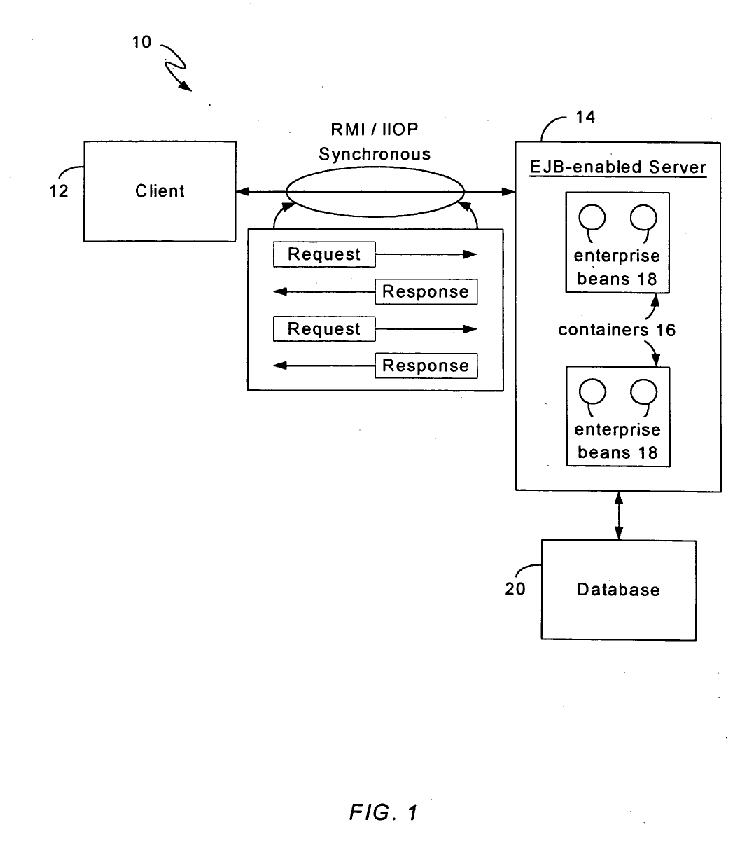

FIG. 2 is a simplified flow chart, of a prior art EJB architecture, illustrating the deployment process of enterprise beans into a container;

FIG. 3 is a simplified block diagram of a prior art EJB architecture having a client system and an EJB-enabled server and using stubs and skeletons to communicate synchronously;

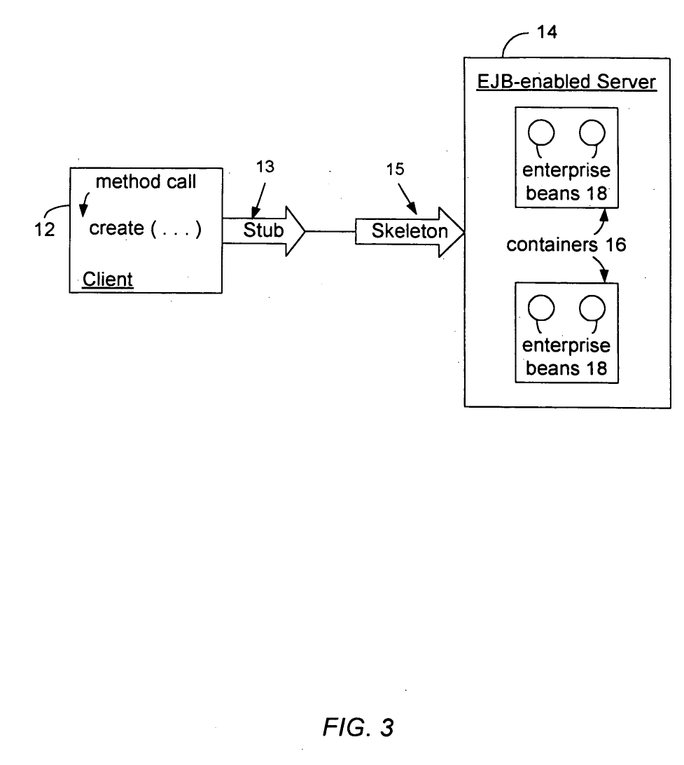

FIG. 4 is a simplified block diagram of a prior art EJB architecture having a client system and an EJB-enabled server and configured to communicate asynchronously at the application level;

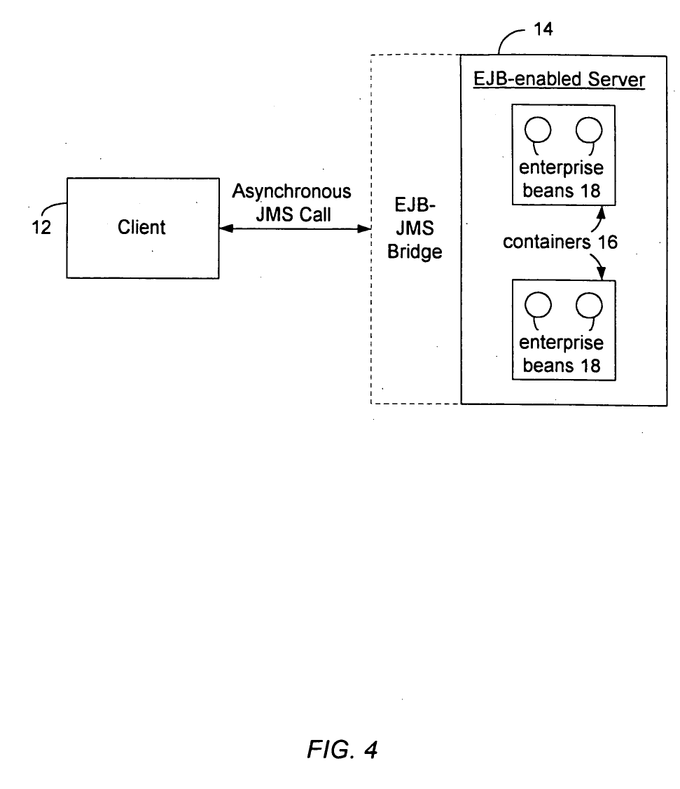

FIG. 5 is a simplified block diagram of a portion of an EJB architecture having an enterprise bean, a proxy bean generator, and a proxy bean, where the proxy bean generator is configured to generate proxy beans;

FIG. 6 is a simplified block diagram of an EJB architecture having client systems, an EJB-enabled server, and a remote server and illustrating the paths of synchronous communication between the client systems, a proxy bean and an enterprise JavaBean;

FIG. 7 is a simplified flow chart illustrating the method of generating proxy beans according to an embodiment of the present invention;

FIG. 8 is a simplified block diagram of an EJB architecture having an application server and a remote server and illustrating the paths of asynchronous communication between a proxy bean and an enterprise JavaBean;

FIG. 9 is a simplified block diagram of an EJB architecture having client systems, a remote server, and an application server, the EJB architecture illustrates the benefits of the present invention with respect to passing data through firewalls using RMI instead of HTTP tunneling; and

FIG. 10 is a simplified block diagram of an EJB architecture having client systems, a remote server, and an application server, the EJB architecture illustrates the load balancing benefits of the present invention.

### DETAILED DESCRIPTION OF THE PREFERRED EMBODIMENT

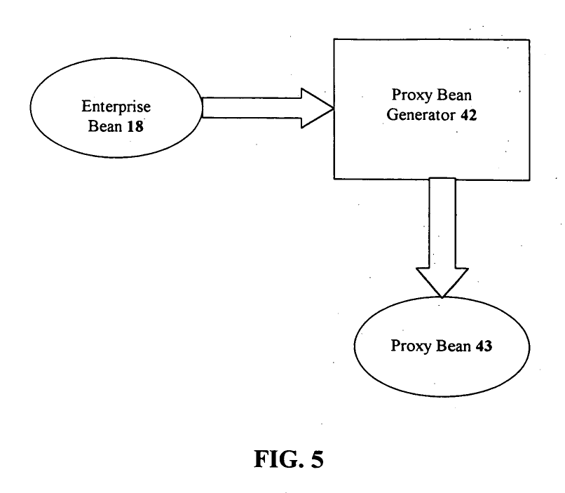

FIG. 5 is a simplified block diagram of a portion of an EJB architecture having an enterprise bean 18, a proxy bean generator 42, and a proxy bean 43, where the proxy bean generator is configured to generate proxy beans. During the deployment process, implementations of the enterprise bean are generated. As described in co-pending U.S. patent application Ser. No. ______, entitled “System and Method of providing a Messaging Engine for an Enterprise JavaBeans-enabled Server to Achieve Container Managed Asynchronous Functionality”; and (2) U.S. patent application Ser. No. ______, entitled “System and Method of providing an Asynchronous Interface between a Client System and an Enterprise JavaBeans-enabled Server,” the EJB-enabled server is configured to generate asynchronous and synchronous enterprise bean implementations. The proxy bean generator 42 is used to generate proxy beans 43, which are representations of EJBs located at remote servers. The proxy bean generator 42 can be used to generate proxy beans 43 during deployment of the enterprise bean 18. In another embodiment, the proxy bean generator 42 can be used to generate proxy beans 43 at a later time by providing the proxy bean generator 42 with information about the enterprise bean. The proxy bean 43 holds or stores information regarding the location of the application server, the type of enterprise bean 18, the method signatures in the enterprise bean 18, etc.

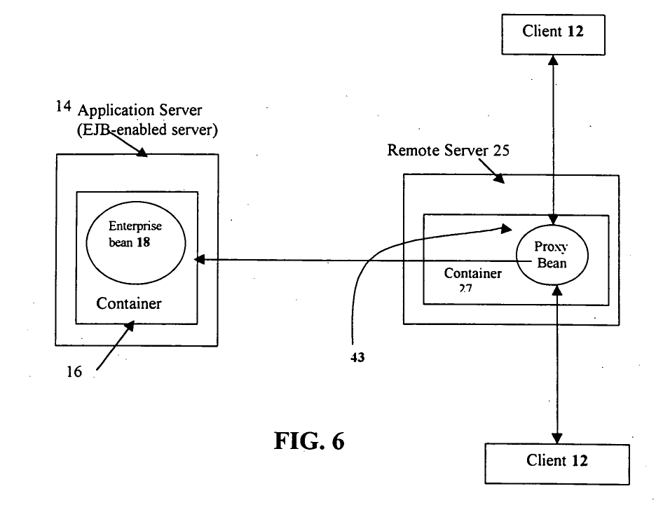

FIG. 6 is a simplified block diagram of an EJB architecture having client systems 12, an application server 14, e.g., an EJB-enabled server, and a remote server 25. The EJB architecture illustrates the paths of synchronous communication between the client systems 12, a proxy bean 43 and an enterprise JavaBean 18. The proxy bean 43 can be deployed into a container 27 of the remote server 25. Once deployed in the remote server 25, the client system 12 can access the proxy bean 43 as if it were a locally deployed enterprise bean 18. Specifically, any client system 12 accessing the proxy bean 43 will be able to access the proxy bean 43 as if it were a locally deployed enterprise bean 18.

Proxy Bean Generation

Whenever an enterprise bean 18 is deployed into a container 16, in addition to the generation of normal wrapper objects (i.e., objects generated by the EJB-enabled server 14 for internal use by the server in handling calls to the EJB), a proxy bean 43 may also be generated. This proxy bean 43 is configured to communicate with the actual enterprise bean 18 by encapsulating information about the application server 14 and container 16 into the enterprise bean being deployed. The proxy bean 43 may be deployed into other remote servers, and at the time of deployment, the proxy bean 43 deployed into each new remote server is also configured to communicate with the actual enterprise bean 18.

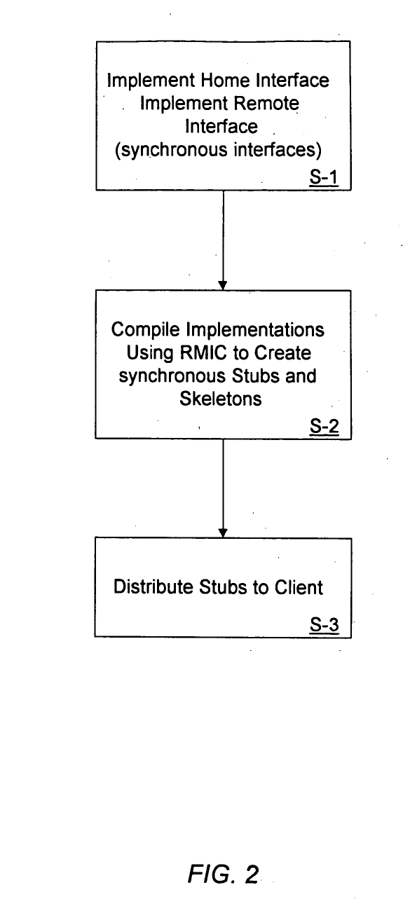

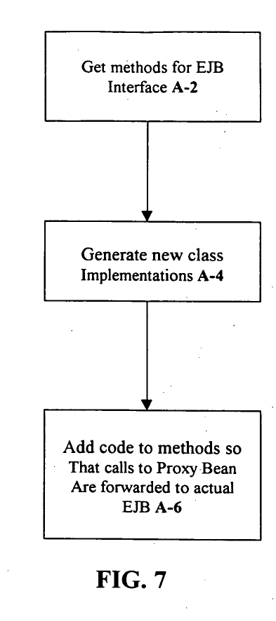

As shown in FIG. 2, the first step S-1 in deployment of a regular enterprise bean is to generate home and remote interface implementations. Referring to FIG. 7, during generation of a proxy bean, the method calls are coded so that the method calls are forwarded to the actual enterprise bean 18 deployed in the application server 14 (see also FIG. 6). Specifically, step A-2 in generating a proxy bean is to get methods from the home and remote interfaces of the enterprise beans. Step A-4 is to generate new class implementations. Step A-6 is to add the code to the methods so that the calls to the proxy bean are forwarded to the actual enterprise bean.

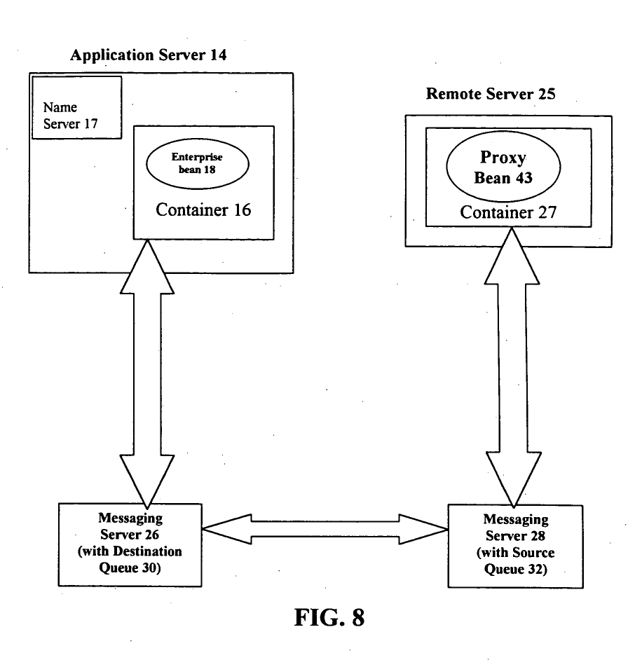

The proxy bean contains information regarding the wrapper objects that are generated for the actual enterprise bean that helps facilitate the client lookup of the enterprise bean and the method calls performed on the enterprise bean. Referring to FIG. 8, the proxy bean also encapsulates the internet protocol (IP) address of the name server 17 which knows the location of the actual enterprise bean 18. The proxy bean later uses this IP address to communicate lookup and method calls from the client system to the actual enterprise bean.

In the case where asynchronous communication is desired, the proxy bean 43 also encapsulates information regarding a destination queue or topic 30, which is the queue or topic where messages intended for the enterprise bean 18 from the proxy bean 43 are sent. (see FIG. 8).

The proxy bean 43 can be generated with all the above described information and can be identified as a Proxy<beanname>.jar archive.

The proxy bean jar file would contain the following class files:

Interface for accessing the actual beans;

Synchronous Home and Remote Interfaces;

Asynchronous Home and Remote Interfaces;

Proxy Implementations (Wrappers for the actual bean calls);

Synchronous Implementation (for Home and Remote Classes);

Asynchronous Implementation (for Home and Remote Classes); and

A Serialized file for other Proxy Details.

The following is a sample enterprise bean used to demonstrate how to generate proxy beans.

The following is a sample Entity Bean's Home Interface and Remote Interface:

```
import javax.ejb.*;
import java.rmi.*;
import java.util.*;
import java.sql.*;
public interface EmpEntityCMP_HI extends javax.ejb.EJBHome,
java.rmi.Remote {
    public EmpEntityCMP_RI create (int id,String name, int sal,
            java.sql.Date joinDate, float netSal, char sex,
            java.sql.Timestamp incomingTime)
            throws RemoteException,CreateException;
    public EmpEntityCMP_RI findByPrimaryKey (EmpEntityCMP_{—}
    PK pk)
            throws RemoteException,FinderException;
    public EmpEntityCMP_RI findByName(String name)
            throws RemoteException, FinderException;
    public Enumeration findBysal(int sal)
            throws RemoteException, FinderException;
    public Enumeration findByNetSal(float netSal)
            throws RemoteException, FinderException;
    public EnumerationFindByJoinDate(java.sql.Date joionDate)
            throws RemoteException, FinderException;
    public Enumeration findBySex(char sex)
            throws RemoteException, FinderException;
    public Enumeration findByIncomingTime(
        java.sql.Timestamp incomingTime)
            throws RemoteException, FinderException;
}
import javax.ejb.*;
import java.rmi.*;
import java.util.*;
import java.sql.*;
public interface EmpEntityCMP_RI extends javax.ejb.EJBObject {
    public String computeGrade( ) throws RemoteException;
    public int getId( ) throws RemoteException;
    public void setId(int id) throws RemoteException;
    public String getName( ) throws RemoteException;
    public void setName(String name) throws RemoteException;
    public void setJoinDate(java.sql.Date joinDate)
            throws RemoteException;
    public java.sql.Date getJoinDate( ) throws RemoteException;
    public void setIncomingTime(java.sql.Timestamp incomingTime)
                throws RemoteException;
    public java.sql.Timestamp getIncomingTime( )
    throws RemoteException;
    public void setSex(char sex) throws RemoteException;
    public char getSex( ) throws RemoteException;
    public void setNetSal(float netSal) throws RemoteException;
    public float getNetSal( ) throws RemoteException;
    public void swapRecords(int recordId) throws RemoteException;
    public void removeAndUpdateRecord(int recordId)
        throws RemoteException;
    public void removeRecord(int recordId) throws RemoteException;
    public int getsal( ) throws RemoteException;
    public void setsal(int sal) throws RemoteException;
    public void updateRecord(int recordId) throws RemoteException;
    public String getCallerName( ) throws RemoteException;
    public boolean getRollback( ) throws RemoteException;
    public void setRollback( ) throws RemoteException;
    public void createRecs( ) throws RemoteException;
}
```

The Implementations generated for the above bean examples are listed below:

```
Synchronous Home Implementation:
import java.lang.*;
import java.util.*;
import java.sql.*;
import java.rmi.*;
import java.security.*;
import javax.ejb.*;
import vanda.server.core.*;
import proxy.core.*;
import vanda.container.core.*;
public class VandaProxySyncEmpEntityCMP_HIImpl extends
proxy.core.VandaProxySyncServiceInterfaceImpl implements
proxy.core.VandaProxyInterface, javax.ejb.EJBHome,
EmpEntityCMP_HI {
    public VandaProxySyncEmpEntityCMP_HIImpl( )
    throws RemoteException {
    }
    public EmpEntityCMP_RI create(int param0, java.lang.String
    param1,
            int param2, java.sql.Date param3, float param4,
            char param5, java.sql.Timestamp param6)
            throws java.rmi.RemoteException,
            javax.ejb.CreateException,
            vanda.container.core.VandaNoSuchClientException,
            vanda.container.core.VandaSecurityException,
        vanda.container.core.VandaHomeUnderMigrationException {
        EmpEntityCMP_HI home = (EmpEntityCMP_HI)
                preCreate(... “EmpEntityCMP_HI” ...);
        EmpEntityCMP_RI ret = home.create(param0, param1,
                param2, param3, param4, param5, param 6);
        EmpEntityCMP_RI proxyRet = (EmpEntityCMP_RI)
                postCreate(ret, “EmpEntityCMP_RI”);
        return proxyRet;
    }
    public EmpEntityCMP_RI findByPrimaryKey( EmpEntityCMP_{—}
    PK param0)
            throws java.rmi.RemoteException,
            javax.ejb.FinderException,
            vanda.container.core.VandaNoSuchClientException,
            vanda.container.core.VandaSecurityException,
            vanda.container.core.
            VandaHomeUnderMigrationException {
        EmpEntityCMP_HI home = (EmpEntityCMP_HI)preFind(...
“EmpEntityCMP_HI” ...);
        EmpEntityCMP_RI ret = home.findByPrimaryKey(param0);
        EmpEntityCMP_RI proxyRet = (EmpEntityCMP_{—}
RI)postFind(ret, “EmpEntityCMP_RI”);
        return proxyRet;
}
... ... ... ... and so on for all finder methods
    public void remove(javax.ejb.Handle param0)
        throws java.rmi.RemoteException, javax.ejb.RemoveException,
        vanda.container.core.VandaNoSuchClientException,
        vanda.container.core.VandaSecurityException,
        vanda.container.core.VandaHomeUnderMigrationException {
        EmpEntityCMP_HI home = (EmpEntityCMP_{—}
HI)preHomeMethod(... “EmpEntityCMP_HI”...);
        home.remove(param0);
        postHomeMethod( );
    }
    public javax.ejb.EJBMetaData getEJBMetaData ( )
        throws java.rmi.RemoteException,
vanda.container.core.VandaNoSuchClientException,
        vanda.container.core.VandaSecurityException,
        vanda.container.core.VandaHomeUnderMigrationException {
        EmpEntityCMP_HI home = (EmpEntityCMP_{—}
HI)preHomeMethod(... “EmpEntityCMP_HI”...);
        javax.ejb.EJBMetaData ret = home.getEJBMetaData( );
        postHomeMethod( );
        return ret;
    }
..............
}
Synchronous Remote Implementation:
import java.lang.*;
import java.util.*;
import java.sql.*;
import java.rmi.*;
import java.security.*;
import javax.ejb.*;
import vanda.server.core.*;
import proxy.core.*;
import vanda.container.core.*;
public class VandaProxySyncEmpEntityCMP_RIImpl
        extends proxy.core.VandaProxySyncServiceInterfaceImpl
        implements proxy.core.VandaProxyInterface,
        javax.ejb.EJBObject, EmpEntityCMP_RI {
    ..............
    public void remove( ) throws java.rmi.RemoteException,
            javax.ejb.RemoveException,
            vanda.container.core.VandaNoSuchClientException,
            vanda.container.core.VandaSecurityException,
            vanda.container.core.
            VandaHomeUnderMigrationException {
        EmpEntityCMP_RI remote =
(EmpEntityCMP_RI)preRemoteMethod(this.objId);
        remote.remove( );
        postRemoteMethod( );
    }
    public javax.ejb.EJBHome getEJBHome( )
    throws java.rmi.RemoteException,
            vanda.container.core.VandaNoSuchClientException,
            vanda.container.core.VandaSecurityException,
            vanda.container.core.
            VandaHomeUnderMigrationException {
        EmpEntityCMP_RI remote =
(EmpEntityCMP_RI)preRemoteMethod(this.objId);
        javax.ejb.EJBHome ret = remote.getEJBHome( );
        postRemoteMethod( );
        return ret;
    }
    public javax.ejb.Handle getHandle( )
    throws java.rmi.RemoteException,
            vanda.container.core.VandaNoSuchClientException,
            vanda.container.core.VandaSecurityException,
            vanda.container.core.
            VandaHomeUnderMigrationException {
        EmpEntityCMP_RI remote =
(EmpEntityCMP_RI)preRemoteMethod(clientId, clientTxContext,
securityId, this.objId);
        javax.ejb.Handle ret =remote.getHandle( );
        postRemoteMethod( );
        return ret;
    }
    /* All Methods .... */
    public java.lang.String computeGrade( )
    throws java.rmi.RemoteException,
            vanda.container.core.VandaNoSuchClientException,
            vanda.container.core.VandaSecurityException,
            vanda.container.core.
            VandaHomeUnderMigrationException {
        EmpEntityCMP_RI remote =
(EmpEntityCMP_RI)preRemoteMethod(this.objId);
        java.lang.String ret = remote.computeGrade( );
        postRemoteMethod( );
        return ret;
    }
    ..................../* Wrapper for All Other Methods */
}
```

In the above code, the Home and Remote Implementations provide wrapper methods for each method defined in the Home and Remote Interfaces. Apart from calling the actual enterprise bean's method, the wrapper performs some pre and post operations at the local server side. The wrapper also provides wrapper methods for EJB methods like Getting the Handle, Getting the Bean Meta Data, etc.

```
Asynchronous Home Implementation:
import java.lang.*;
import java.util.*;
import java.sql.*;
import java.rmi.*;
import java.security.*;
import javax.ejb.*;
import vanda.server.core.*;
import proxy.core.*;
import vanda.container.core.*;
public class VandaProxyAsyncEmpEntityCMP_HIImpl
        extends proxy.core.VandaProxyAsyncServiceInterfaceImpl
        implements javax.ejb.EJBHome {
    ...............
    public AsyncEmpEntityCMP_RI create( int param0,
    java.lang.String param1,
                int param2, java.sql.Date param3, float param4,
                char param5, java.sql.Timestamp param6)
                throwsjava.rmi.RemoteException,
javax.ejb.CreateException,
                Exception,
vanda.container.core.VandaNoSuchClientException,
                vanda.container.core.VandaSecurityException,
    vanda.container.core.VandaHomeUnderMigrationException {
        AsyncEmpEntityCMP_HI home =
(AsyncEmpEntityCMP_HI)preCreate(... “EmpEntityCMP_HI”...);
        long ret = home.create(param0, param1, param2,
param3, param4, param5, param6);
        return (AsyncEmpEntityCMP_RI ) home.getResult(ret);
    }
    public AsyncEmpEntityCMP_RI findByPrimaryKey(
EmpEntityCMP_PK param0)
            throws java.rmi.RemoteException,
            javax.ejb.FinderException,
            vanda.container.core.VandaNoSuchClientException,
            vanda.container.core.VandaSecurityException,
            vanda.container.core.
            VandaHomeUnderMigrationException {
        AsyncEmpEntityCMP_HI home = (AsyncEmpEntityCMP_{—}
HI)preFind( ... “EmpEntityCMP_HI”... );
        long ret = home.findByPrimaryKey(param0);
        return (AsyncEmpEntityCMP_RI ) home.getResult( ret);
    }
........... All Other Finder methods ........
    public javax.ejb.HomeHandle getHomeHandle(long clientId,
VandaTransactionContext clientTxContext,Principal securityId) throws
java.rmi.RemoteException, Exception,
vanda.container.core.VandaNoSuchClientException,
vanda.container.core.VandaSecurityException,
vanda.container.core.VandaHomeUnd
erMigrationException {
        AsyncEmpEntityCMP_HI home =
(AsyncEmpEntityCMP_HI)preHomeMethod(... “EmpEntityCMP_HI”...);
        long ret = home.getHomeHandle( );
        return (javax.ejb.HomeHandle) home.getResult(ret);
    }
    /* Some other utility methods .... */
    ...................
}
Asynchronous Remote Implementation:
import java.lang.*;
import java.util.*;
import java.sql.*;
import java.rmi.*;
import java.security.*;
import javax.ejb.*;
import vanda.server.core.*;
import proxy.core.*;
import vanda.container.core.*;
public class VandaProxyAsyncEmpEntityCMP_RIImpl
        extends proxy.core.VandaProxyAsyncServiceInterfaceImpl {
    .......................
    public java.lang.String getName( )
            throws java.rmi.RemoteException, Exception,
            vanda.container.core.VandaNoSuchClientException,
            vanda.container.core.VandaSecurityException,
            vanda.container.core.
            VandaHomeUnderMigrationException {
        long ret = remoteAsyncStub.getName( );
        return ( java.lang.String ) remoteAsyncStub.getResult(ret);
    }
    /* Wrapper for All Other Methods */
    ....................
}
```

The above is an Asynchronous Implementation of the proxy bean where the Implementation wraps around the same signature calls and calls the actual bean asynchronously. The thread between the proxy bean and the actual enterprise bean is blocked until the result arrives or an exception occurs, but this would not block the client system (or other client systems) from making additional calls since these methods are executed using a different thread context.

Proxy Bean Deployment:

When a proxy bean 43 is deployed it is not necessary to edit deployment descriptors or map the bean fields to table columns as is normally done. Instead, the user should specify the archive (.jar) that is created when a proxy bean is generated. In the case where asynchronous communication is desired (see FIG. 8), the user should also specify the messaging attributes for contacting the messaging server 26. The proxy bean has two messaging configurations: one called the proxy descriptor which refers to the home-messaging server 26 available locally at the local server end and the other is the remote-messaging server 28, which details where the remote server 25 looks for messages.

In order for the proxy bean to access the actual enterprise bean, the proxy bean needs the Synchronous/Asynchronous home and remote interfaces and stubs of the actual beans. If the communication is synchronous, then the RMI stubs 13 are necessary. If the communication is asynchronous, then the asynchronous stubs need to be present at the local server side, as described in co-pending U.S. patent application Ser. No. ______, entitled “System and Method of providing a Messaging Engine for an Enterprise JavaBeans-enabled Server to Achieve Container Managed Asynchronous Functionality.”

The Asynchronous Interface packaged along with the Proxy JAR file:

```
import java.lang.*;
import java.util.*;
import java.sql.*;
import java.rmi.*;
import java.security.*;
import javax.ejb.*;
import vanda.client.messaging.*;
import vanda.generic.client.*;
public interface AsyncEmpEntityCMP_HI
{
    public long create(int param0, java.lang.String param1, int param2,
        java.sql.Date param3, float param4, char param5,
        java.sql.Timestamp param6) throws java.rmi.RemoteException,
        javax.ejb.CreateException;
    public long findByPrimaryKey(EmpEntityCMP_PK param0)
        throws java.rmi.RemoteException, javax.ejb.FinderException;
    public long findByName(java.lang.String param0)
        throws java.rmi.RemoteException, javax.ejb.FinderException;
    public long findBysal(int param0)
        throws java.rmi.RemoteException, javax.ejb.FinderException;
    public long findByNetSal(float param0)
        throws java.rmi.RemoteException, javax.ejb.FinderException;
    public long findByJoinDate(java.sql.Date param0)
        throws java.rmi.RemoteException, javax.ejb.FinderException;
    public long findBySex(char param0)
        throws java.rmi.RemoteException, javax.ejb.FinderException;
    public long findByIncomingTime(java.sql.Timestamp param0)
        throws java.rmi.RemoteException, javax.ejb.FinderException;
    public Object getResult( long callId) throws Exception;
    public boolean getStatus( long callId)
        throws VandaResultAlreadyReceivedException;
    public long remove( java.lang.Object primKey)
        throws RemoteException;
    public long remove( VandaMessagingHandle handle)
        throws RemoteException;
    public void releaseMessagingService( );
    public void addListener( VandaMessagingEventListener e) ;
    public VandaMessagingEJBMetaDataInterface getEJBMetaData( );
    public long getHomeHandle( ) throws java.rmi.RemoteException;
}
Asynchronous Remote Interface:
import java.lang.*;
import java.util.*;
import java.sql.*;
import java.rmi.*;
import java.security.*;
import vanda.generic.client.*;
import vanda.client.messaging.*;
import javax.ejb.*;
public interface AsyncEmpEntityCMP_RI
{
    public long getName( ) throws java.rmi.RemoteException;
    public long setName(java.lang.String param0)
            throws java.rmi.RemoteException;
    public long getId( ) throws java.rmi.RemoteException;
    public long computeGrade( ) throws java.rmi.RemoteException;
    public long setId(int param0) throws java.rmi.RemoteException;
    public long setJoinDate(java.sql.Date param0)
            throws java.rmi.RemoteException;
    public long getJoinDate( ) throws java.rmi.RemoteException;
    public long setIncomingTime(java.sql.Timestamp param0)
            throws java.rmi.RemoteException;
    public long getIncomingTime( ) throws java.rmi.RemoteException;
    //Other Business methods signatures
    public Object getResult( long callId ) throws Exception;
    public boolean getStatus( long callId )
            throws VandaResultAlreadyReceivedException;
    public long getHandle( ) throws RemoteException;
    public long remove( ) throws RemoteException;
    public void releaseMessagingService( ) ;
    public void addListener( VandaMessagingEventListener e) ;
    public VandaMessagingStub getEJBHome( );
    public Object getPrimaryKey( );
    public boolean isIdentical(Object obj);
}
```

Use of Proxy Beans:

When the proxy bean is deployed at the client side, the proxy bean is associated with the JNDI (Java Naming and Directory Interface) NameSpace of the client system. This allows the client system to access the beans locally, thereby eliminating the problems associated with a remote lookup.

Referring to FIG. 6 and FIG. 8, client systems 12 can access the proxy bean synchronously and/or asynchronously (if asynchronous capabilities have been implemented—one way of implementing asynchronous capability is described in the two co-pending patent applications filed concurrently with this patent application. The proxy bean forwards (either synchronously or asynchronously) all the method invocations (calls) to the actual enterprise bean deployed in the remote server. From the client system's perspective, it appears as if the actual enterprise bean is being accessed.

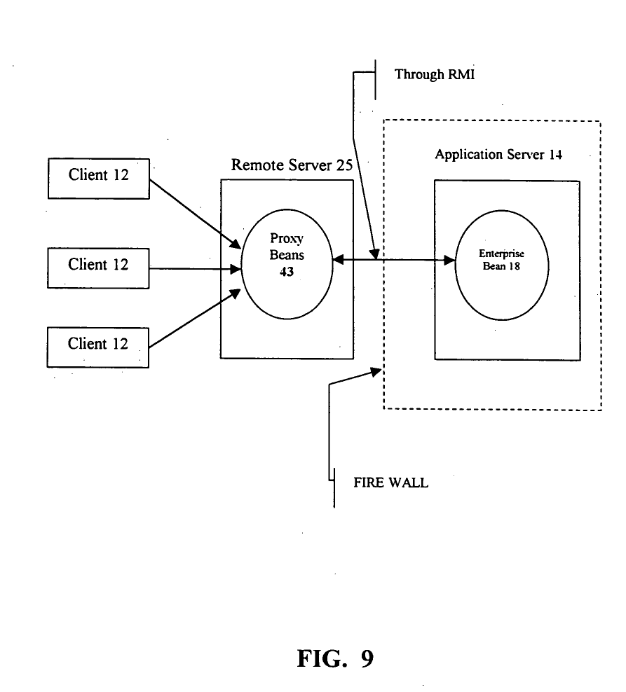

FIG. 9 demonstrates how use of proxy beans 43 can more efficiently enable several client systems 12 to access an application server 14 through a firewall. If the client systems 12 were to access the enterprise bean 18 directly through the firewall, there would need to be “a hole punched” in the firewall for each client system 12. With the use of proxy beans 43 and a remote server 25, several client systems 12 can access the enterprise bean 18 through the proxy bean 43, thereby only requiring one hole in the fire wall.

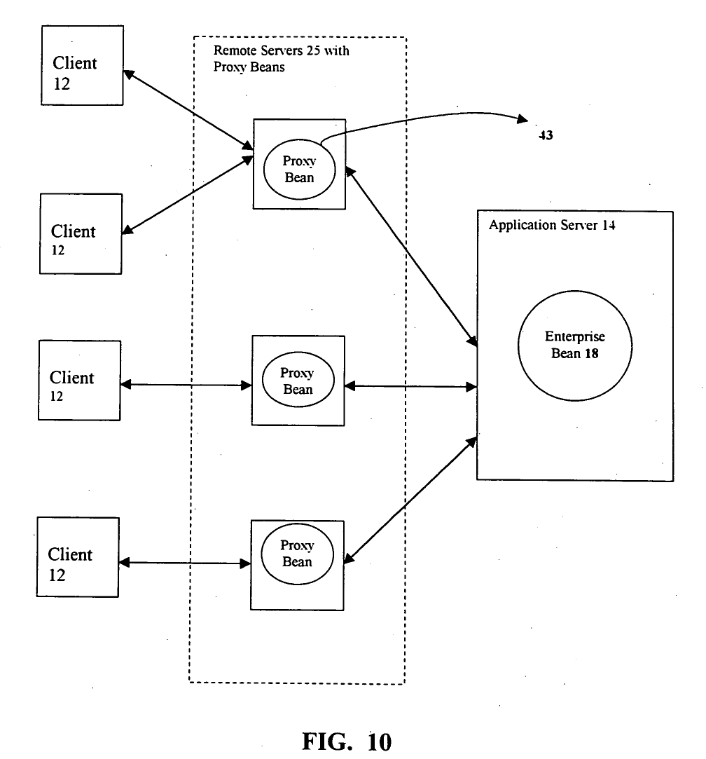

FIG. 10 demonstrates how proxy beans can be used for load balancing. Client systems 12 may access the application server 14 and the enterprise bean 18 through proxy beans 43 and remote servers 25. The use of remote servers 25 limits the load on the application server 14.

The foregoing detailed description of the present invention is provided for the purposes of illustration and is not intended to be exhaustive or to limit the invention to the precise embodiment disclosed. Accordingly, the scope of the present invention is defined by the following claims.

What is claimed is:

1. An enterprise JavaBeans architecture, comprising:
an application server having a container and a plurality of enterprise beans residing in the container;
a remote server having a container and a plurality of proxy beans residing in the container and configured to communicate with the application server, the plurality of proxy beans being deployed on the remote server; and
a plurality of client systems configured to communicate with the plurality of proxy beans of the remote server.

2. An enterprise JavaBeans architecture as defined in claim 1, further comprising a firewall connected between the application server and the remote server, the firewall configured to receive requests from the remote server using remote method invocation.

3. An enterprise JavaBeans architecture as defined in claim 1, wherein the application server is an enterprise JavaBeans-enabled server.

4. An enterprise JavaBeans architecture as defined in claim 1, wherein each of the plurality of proxy beans is a representation of one of the plurality of enterprise beans.

5. An enterprise JavaBeans architecture as defined in claim 1, wherein each of the plurality of proxy beans access data using one of the plurality of enterprise beans.

6. An enterprise JavaBeans architecture as defined in claim 1, wherein the plurality of proxy beans do not access data directly from the application server.

7. An enterprise JavaBeans architecture as defined in claim 1, wherein each of the plurality of client systems perform a lookup operation to access the plurality of proxy beans.

8. An enterprise JavaBeans architecture as defined in claim 1, wherein each of the plurality of client systems is configured to make a method call to the remote server that contains the proxy bean corresponding to the client system configured to make the method call.

9. An enterprise JavaBeans architecture as defined in claim 8, wherein the remote server transmits the method call to the corresponding enterprise bean residing in the container of the application server.

10. In an enterprise JavaBean architecture having a plurality of client systems, an application server having a container and a plurality of enterprise beans residing in the container, and a remote server having a container and a plurality of proxy beans residing in the container, where the plurality of client systems are configured to communicate with the remote server and the remote server is configured to communicate with the application server, a method of using a proxy bean to provide asynchronous communication between the application server and the remote server, comprising:
generating a plurality of proxy beans;
deploying the plurality of proxy beans into the container of the remote server;
performing a method call on at least one of the plurality of proxy beans;
transmitting the method call to one of the plurality of enterprise beans located at the application server; and
accessing the enterprise bean having the method call.

11. A method as defined in claim 10, wherein generating the plurality of proxy beans occurs during deployment of the plurality of enterprise beans.

12. A method as defined in claim 10, further comprising accessing the plurality of proxy beans using the plurality of client systems.

13. A method as defined in claim 10, further comprising accessing the plurality of proxy beans using the plurality of enterprise beans.

14. A method as defined in claim 13, wherein accessing the plurality of proxy beans using the plurality of enterprise beans comprises providing each of the plurality of proxy beans with a remote method invocation stub corresponding to each of the plurality of proxy beans.

15. A method as defined in claim 13, wherein accessing the plurality of proxy beans using the plurality of enterprise beans comprises providing each of the plurality of proxy beans with an asynchronous stub corresponding to each of the plurality of proxy beans.

16. A method as defined in claim 10, further comprising encapsulating information about the application server and its container into the enterprise bean being deployed.

17. A method as defined in claim 10, wherein the at least one of the plurality of proxy beans is a representation of the enterprise bean having the method call.

18. A method as described in claim 10, wherein accessing the enterprise bean having the method call is accomplished using the at least one of the plurality of proxy beans.

19. A method as defined in claim 10, wherein each of the plurality of proxy beans includes application server information, enterprise bean information and method call information.

20. A method as defined in claim 19, wherein each of the plurality of proxy beans further includes destination information.

21. A method as defined in claim 10, wherein each of the plurality of proxy beans is a representation of one of the plurality of enterprise beans.

22. A method as defined in claim 10, wherein generating the plurality of proxy beans includes retrieving method calls from home and remote interfaces of the plurality of enterprise beans.

23. A method as defined in claim 22, further comprising generating new class implementations of the home and remote interfaces of the plurality of enterprise beans.
